(19) United States
(12) Patent Application Publication
(10) Pub. No.: US 2020/0119421 A1
(43) Pub. Date: Apr. 16, 2020

(54) ECO-FRIENDLY ENERGY STORAGE SYSTEM FOR FREQUENCY REGULATION

(71) Applicant: ACROLABS INC., Seongnam-si, Gyeonggi-do (KR)

(72) Inventors: Hosuk KIM, Yongin-si, Gyeonggi-do (KR); Taehyun HONG, Seoul (KR)

(73) Assignee: ACROLABS INC., Seongnam-si, Gyeonggi-do (KR)

(21) Appl. No.: 16/477,899

(22) PCT Filed: Apr. 30, 2018
(86) PCT No.: PCT/KR2018/005041

§ 371 Date: Jul. 14, 2019

(30) Foreign Application Priority Data
Apr. 28, 2017 (KR) 10-2017-0054931

(51) Int. Cl. H01M 16/00; C25B 1/04; H01M 8/04082; H01M 8/0656; C25B 9/08; H01M 8/04746; H02J 3/38

(52) U.S. Cl. CPC H01M 16/003; C25B 1/04; H01M 8/04201; H01M 8/0656; H02J 2300/20; H01M 8/04753; H02J 3/381; H01M 2250/40; C25B 9/08

(57) ABSTRACT

An eco-friendly energy storage system for frequency regulation, includes: a water electrolysis apparatus and a hydrogen storage apparatus for performing discharge of surplus power for a power system; a fuel cell power generation apparatus for performing charge of deficiency power; and a control device for controlling charge and discharge by detecting a system frequency for controlling charge and discharge of the system, comparing the system frequency with a frequency reference value, and reflecting a frequency regulation amount calculated on the basis of a hydrogen storage amount of the system.

### TECHNICAL FIELD

The present invention relates to an energy storage system operated according to change of system frequency, and more specifically, to an eco-friendly energy storage system which can be effectively used since the system may store surplus power as hydrogen for the change of frequency in a power system and may generate power when needed.

### BACKGROUND ART

A representative energy storage system (ESS) used for conventional power systems is a system which can enhance efficiency of energy by storing electricity produced during the midnight time of low load and supplying the electricity at the peak hours in the daytime when needed. Pumping generators are used as the representative energy storage system, and recently, energy storage systems using a battery are diversely developed and distributed.

Presently, frequency regulation is in operation in Korea on coal-fired generators, oil-fired generators, combined cycle generators, hydropower generators and the like using governor free (G/F) and auto-generation control (AGC) driving or the like to maintain power system frequencies changing in real-time.

Energy storage systems such as batteries attracting interest recently are advantageous in that fuel cost of coal-fired generators is reduced and efficiency of the generators are enhanced in substitution for the roles of governor free (G/F) and auto-generation control (AGC) as the energy storage systems can immediately charge and discharge electricity.

However, an energy storage system using a battery, such as a lead-acid battery, a lithium-ion battery (LIB), a sodium-sulfur (NaS) battery or a redox flow battery (RFB), needs to be periodically replaced as performance is degraded according to ambient temperature using the system and the number of times of charge and discharge, and since constituents configuring the battery contain a lot of harmful substances, a considerable amount of cost is expected for disposal of the battery in the event of replacement. Therefore, the need of eco-friendly energy storage systems for frequency regulation is emerging.

### DISCLOSURE OF INVENTION

### Technical Problem

Therefore, the present invention has been made in view of the above problems, and it is an object of the present invention to provide an eco-friendly energy storage system which uses clean hydrogen as an energy storage means by configuring an energy storage apparatus for frequency regulation to include a water electrolysis apparatus and a hydrogen storage apparatus for discharging surplus power of the system and converting and storing the surplus power as hydrogen fuel, and a fuel cell power generation apparatus for charging deficiency power for the system when the energy storage apparatus is applied, to provide a further efficient eco-friendly energy storage system which reduces maintenance cost according to the replacement cycle of the energy storage apparatus using a battery and solves the problem of disposing used batteries.

### Technical Solution

To accomplish the above object, according to one aspect of the present invention, there is provided an eco-friendly energy storage system including: a water electrolysis apparatus and a hydrogen storage apparatus for converting power into hydrogen; and a fuel cell power generation apparatus for generating power through electrochemical reaction of hydrogen and oxygen, and the present invention provides a method of controlling charge and discharge of the eco-friendly energy storage system by detecting a system frequency, comparing the system frequency with a frequency reference value, and reflecting a frequency regulation amount calculated on the basis of a hydrogen storage amount of the eco-friendly energy storage system.

In addition, the present invention includes a method of actively controlling, when the surplus power of the eco-friendly energy storage system is discharged, direct current voltage (V) of the water electrolysis apparatus to effectively convert the surplus power into hydrogen fuel through decrease and increase of an amount of DC current flowing through the water electrolysis apparatus and store the hydrogen fuel therein, and controlling, when deficiency power of the eco-friendly energy storage system is charged, an amount of current flowing through a fuel cell stack to control output in real time.

In addition, an alkaline water electrolysis apparatus is preferable when the water electrolysis apparatus has a large capacity, and a polymer electrolyte membrane (PEM) water electrolysis apparatus or an anion electrolyte membrane (AEM) water electrolysis is preferable as a water electrolysis apparatus having a large installation area or high efficiency.

In addition, it is preferable to use a phosphoric acid fuel cell (PAFC) or a solid oxide fuel cell (SOFC) as the fuel cell power generation apparatus including a hydrogen pressure controller and most preferable to use a polymer electrolyte membrane fuel cell (PEMFC) whose operation temperature is room temperature.

In addition, to mitigate the irregular output characteristic of a new renewable energy generator, the eco-friendly energy storage system includes: a water electrolysis apparatus and a hydrogen storage apparatus for performing discharge of surplus power; a fuel cell power generation apparatus for performing charge of deficiency power; and a control device for controlling charge and discharge by detecting a system frequency for controlling charge and discharge of the system, comparing the system frequency with a frequency reference value, and reflecting a frequency regulation amount calculated on the basis of a hydrogen storage amount of the system.

In addition, the eco-friendly energy storage system includes a compressor between the water electrolysis apparatus and the hydrogen storage apparatus of the system to reduce the size of the hydrogen storage apparatus.

Preferably, an eco-friendly energy storage system according to another embodiment of the present invention includes: a water electrolysis apparatus and a hydrogen storage apparatus for performing discharge of surplus power for a power system; a fuel cell power generation apparatus for performing charge of deficiency power; and a control device for controlling charge and discharge by detecting a system voltage for controlling charge and discharge of the system, comparing the system voltage with a voltage reference value, and reflecting a system voltage regulation amount calculated on the basis of a hydrogen storage amount of the system.

### Advantageous Effects

According to the present invention as described above, maintenance cost, battery replacement cost and the like that may occur in an energy storage system using a battery for frequency regulation can be drastically reduced, and there is an effect of suppressing increase of charges for electricity by improving the use rate of low-cost generators while supplying power of good quality through frequency regulation by using an eco-friendly energy storage system which can fundamentally remove generation of harmful substances which may occur when batteries are disposed.

### BRIEF DESCRIPTION OF THE DRAWINGS

FIG. 1 is a view schematically showing an eco-friendly energy storage system for frequency regulation according to an embodiment of the present invention.

FIG. 2 is a flowchart illustrating control of an eco-friendly energy storage system according to change of system frequency according to an embodiment of the present invention.

FIG. 3 is a view showing a control method in an eco-friendly energy storage system according to an embodiment of the present invention.

FIG. 4 is a view schematically showing an eco-friendly energy storage system, which illustrates output stabilization of a new renewable energy generator, such as a solar power generator, a wind power generator or the like, in a power system including the new renewable energy generator as an embodiment of the present invention.

FIG. 5 is a flowchart illustrating control of an eco-friendly energy storage system according to change of system voltage according to an embodiment of the present invention.

### BEST MODE FOR CARRYING OUT THE INVENTION

Hereinafter, the present invention will be described in detail with reference to the accompanying drawings. In addition, in describing the present invention, if it is determined that the detailed description on the related known art may obscure the gist of the present invention, the detailed description will be omitted.

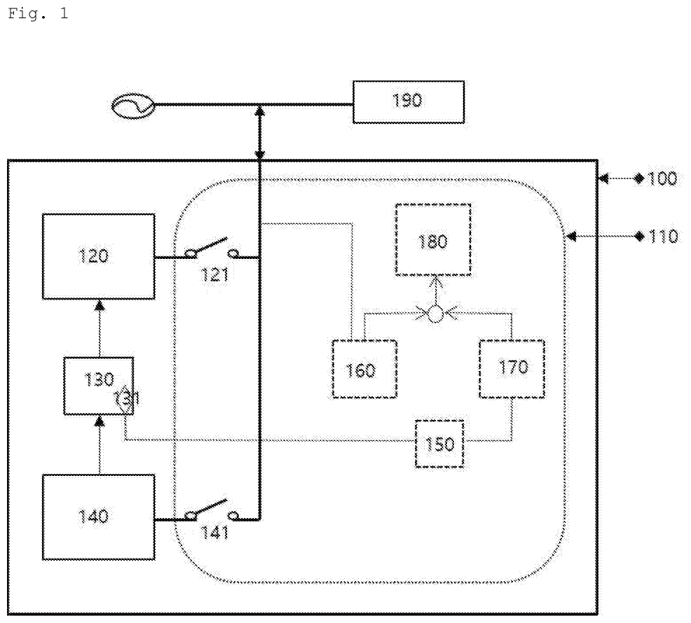

FIG. 1 is a view schematically showing an eco-friendly energy storage system for frequency regulation according to an embodiment of the present invention. As shown in FIG. 1, an eco-friendly energy storage system 100 includes a fuel cell power generation apparatus 120 for producing power through electrochemical reaction of hydrogen and air when deficiency power of the power system 190 is charged (supplemented), a water electrolysis apparatus 140 and a hydrogen storage apparatus 130 for producing hydrogen using the power when surplus power of the power system 190 is discharged (used), and a control device configured of power switches 121 and 141 for controlling flow of current when power is charged or discharged, a system frequency detection unit 160 for measuring a system frequency, a hydrogen storage amount calculation unit 150 for calculating an amount of hydrogen actually stored in the hydrogen storage apparatus 130 from the maximum hydrogen storage amount according to the capacity of the hydrogen storage apparatus and the pressure gauge 131 of the hydrogen storage apparatus, and a charge and discharge control unit 180 for controlling charge and discharge of the power system on the basis of a system frequency regulation amount calculation unit 170 and the data when the power is charged or discharged.

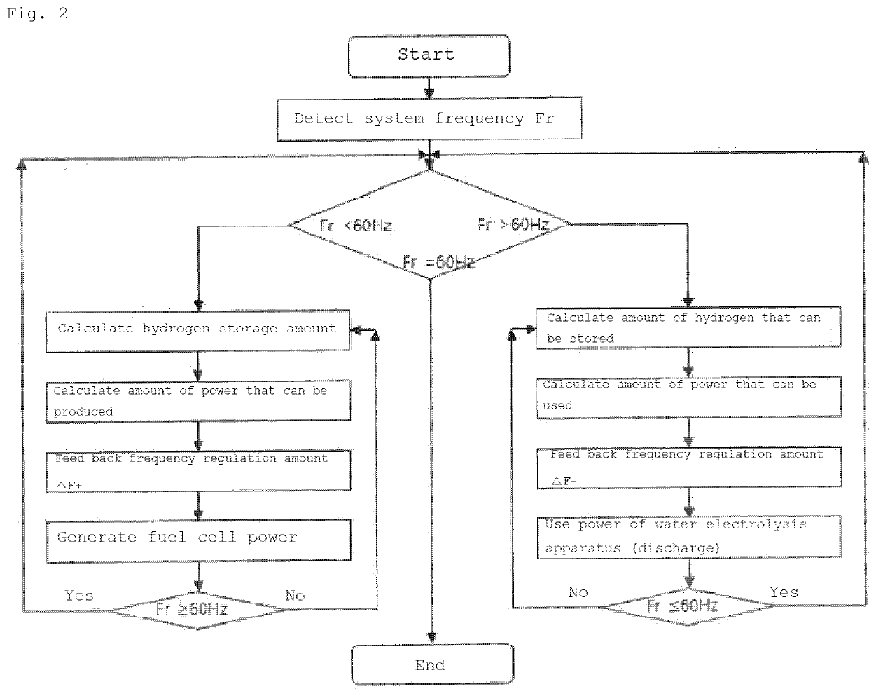

FIG. 2 is a flowchart illustrating control of an eco-friendly energy storage system according to change of system frequency according to an embodiment of the present invention. In FIG. 2, if a frequency detected by the system frequency detection unit 160 is lower than a reference value of 60 Hz, deficiency power of the power system 190 is charged (supplemented) by generating power using the fuel cell power generation apparatus 120. At this point, the system frequency regulation amount calculation unit 170 calculates an amount of power that can be generated from the hydrogen storage amount of the hydrogen storage amount calculation unit 150, and deficiency power of the power system 190 is charged (supplemented) while a controllable frequency regulation amount (ΔF+) is fed back on the basis of the calculated power amount. In addition, if the frequency detected by the system frequency detection unit 160 is higher than the reference value of 60 Hz, hydrogen is produced using the surplus power of the power system 190 as the power of the water electrolysis apparatus 140 and discharged (used) while being stored in the hydrogen storage apparatus 130. At this point, the system frequency regulation amount calculation unit 170 calculates an amount of power that can be used, by calculating a production amount of hydrogen that can be stored in the hydrogen storage apparatus 130 from the difference between the maximum hydrogen storage amount determined according to the capacity of the hydrogen storage apparatus 130 and a real-time hydrogen storage amount, and the surplus power of the power system 190 is discharged (used) while a controllable frequency regulation amount (ΔF−) is fed back on the basis of the calculated power amount.

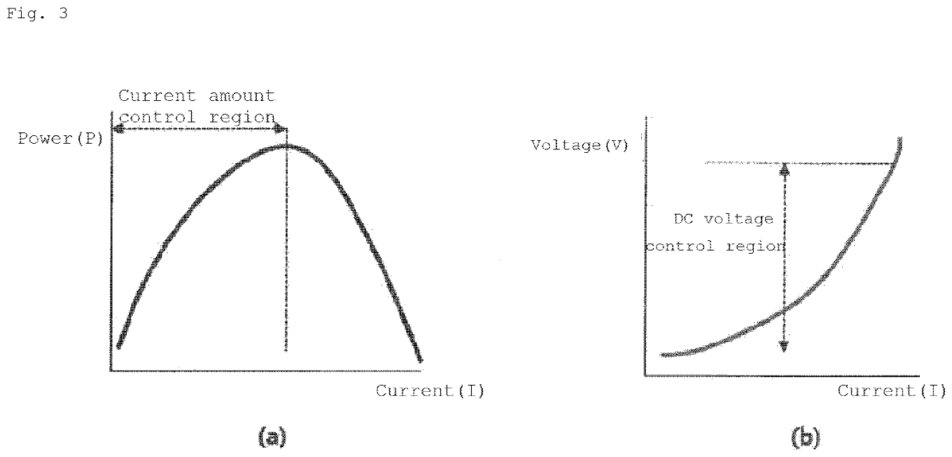

FIG. 3 is a view showing a control method in an eco-friendly energy storage system according to an embodiment of the present invention. FIG. 3(a) is a view showing a performance curve of power (P) and current (I) of a fuel cell power generation apparatus, which illustrates the current amount control region of direct current (DC) flowing through a fuel cell power generation apparatus up to the maximum output of the fuel cell power generation apparatus, and FIG. 3(b) is a view showing a performance curve of DC voltage (V) applied to the water electrolysis apparatus and DC current (I) flowing through the water electrolysis apparatus, which illustrates the control region of the DC voltage for controlling up to the DC voltage at which the water electrolysis apparatus is not permanently destroyed. As shown in FIG. 3, the eco-friendly energy storage system can be optimized by controlling feedback of an amount of power produced by the fuel cell power generation apparatus and an amount of surplus power used by the water electrolysis apparatus, as much as an amount needed for frequency regulation (ΔF+, ΔF−).

The types of the water electrolysis apparatus of the system include alkaline water electrolysis, polymer electrolyte membrane (PEM) water electrolysis, and anion electrolyte membrane (AEM) water electrolysis. Although alkaline water electrolysis apparatuses are commercialized as the price and capacity are favorable, it is disadvantageous in that KOH needs to be separately supplied; there is a problem of residual oxygen in hydrogen together with the problem of corrosion; an additional refining apparatus for producing high-purity pure water is needed; and high pressure storage is not allowed. Although a polymer electrolyte membrane (PEM) water electrolysis apparatus is highly efficient and capable of producing high-purity hydrogen, it has a small capacity, and use of a precious metal catalyst is inevitable due to reaction in an acid environment, and thus the biggest disadvantage is high price, and since moisture is contained in the generated hydrogen, a separate drying process is also needed to store the hydrogen. Finally, an anion electrolyte membrane (AEM) water electrolysis apparatus may produce high-purity hydrogen at a low price without a precious metal catalyst, and particularly, since the cathode is not deposited in the water (dry cathode), there is an advantage in that moisture is not contained in the generated hydrogen, and thus the hydrogen can be directly stored.

The water electrolysis apparatus of the system is any one among alkaline water electrolysis, polymer electrolyte membrane (PEM) water electrolysis, and anion electrolyte membrane (AEM) water electrolysis.

The fuel cell power generation apparatus of the system is a high-efficiency power generation apparatus for producing electric power through electrochemical reaction of hydrogen and oxygen in the air and may be divided into a polymer electrolyte membrane fuel cell (PEMFC) operating at room temperature, a phosphoric acid fuel cell (PAFC) operating at about 200° C., and a solid oxide fuel cell (SOFC) operating between 600 and 800° C. according to the type of electrolyte.

The fuel cell power generation apparatus of the system includes a hydrogen pressure controller and is any one among a polymer electrolyte membrane fuel cell (PEMFC), a phosphoric acid fuel cell (PAFC), and a solid oxide fuel cell (SOFC), which can use pure hydrogen as a fuel.

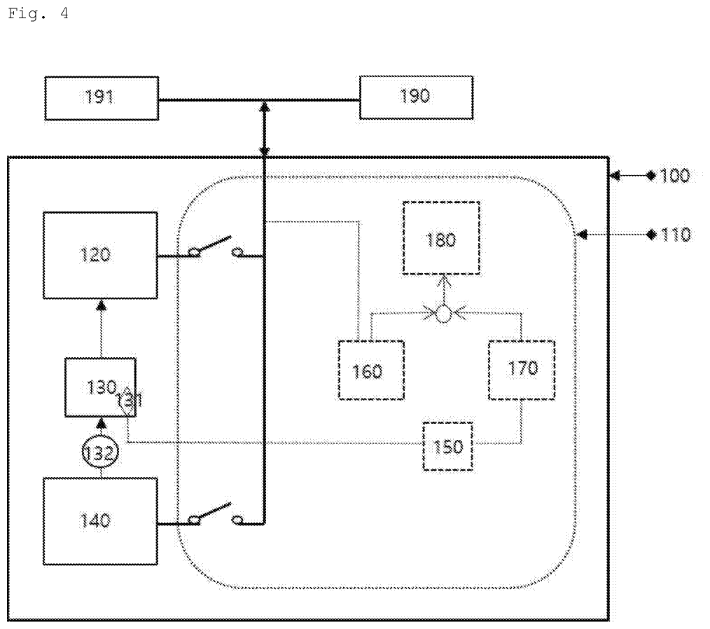

FIG. 4 is a view showing a power system including a new renewable energy generator 191 such as a solar power generator, a wind power generator or the like as an embodiment of the present invention, in which an eco-friendly energy storage system 100 includes a fuel cell power generation apparatus 120 for producing power through electrochemical reaction of hydrogen and air when deficiency power of the power system 190 is charged (supplemented), a water electrolysis apparatus 140 and a hydrogen storage apparatus 130 for producing hydrogen using the power when surplus power of the power system 190 is discharged (used), and a control device configured of a system frequency detection unit 160 for measuring a system frequency, a hydrogen storage amount calculation unit 150 for calculating an amount of hydrogen actually stored in a high pressure storage compressor 132, which can reduce the size of the hydrogen storage apparatus 130, and stored in the hydrogen storage apparatus 130 from the maximum hydrogen storage amount according to the capacity of the hydrogen storage apparatus and the pressure gauge 131 of the hydrogen storage apparatus, and a charge and discharge control unit 180 for controlling charge and discharge of the power system on the basis of a system frequency regulation amount calculation unit 170 and the data when the power is charged or discharged. In addition to frequency regulation according to change of power consumption, customer power can be stabilized by mitigating irregular output instability of new renewable energy by utilizing the eco-friendly energy storage system.

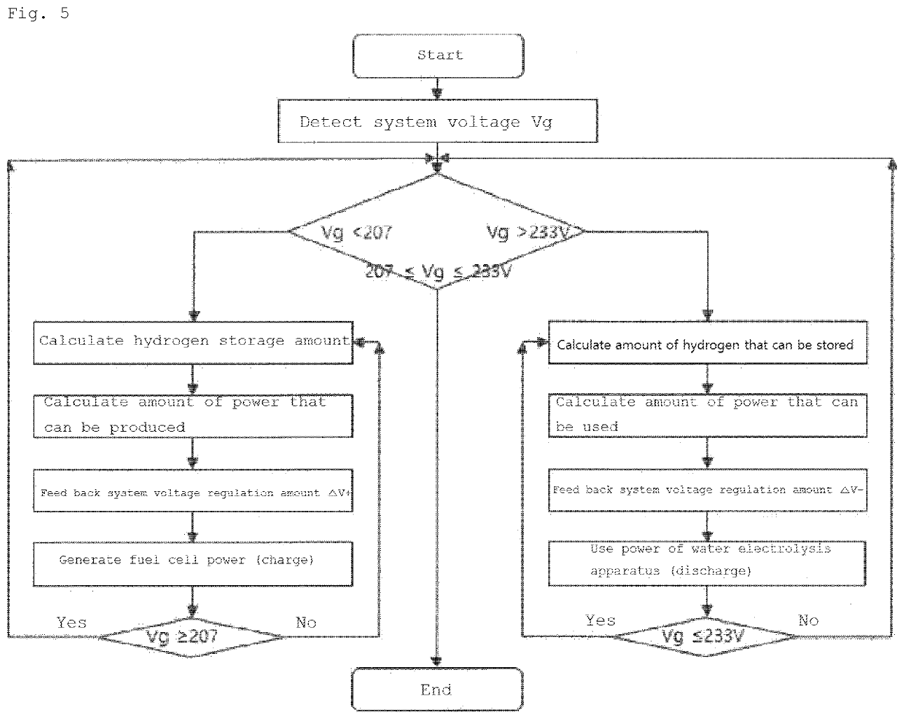

FIG. 5 is a flowchart illustrating control of an eco-friendly energy storage system according to change of system voltage according to an embodiment of the present invention. Although a schematic view of the system is not shown, if system voltage detected by a system voltage detection unit is lower than a reference value of 207V, deficiency power of the power system is charged (supplemented) by generating power using the fuel cell power generation apparatus. At this point, a system voltage regulation amount calculation unit calculates an amount of power that can be generated from the hydrogen storage amount of the hydrogen storage amount calculation unit, and deficiency power of the power system is charged (supplemented) while a controllable system voltage regulation amount (ΔVg+) is fed back on the basis of the calculated power amount. In addition, if the system voltage detected by the system voltage detection unit is higher than a reference value of 233V, hydrogen is produced using the surplus power of the power system as the power of the water electrolysis apparatus and discharged (used) while being stored in the hydrogen storage apparatus. At this point, the system voltage regulation amount calculation unit calculates an amount of power that can be used, by calculating a production amount of hydrogen that can be stored in the hydrogen storage apparatus from the difference between the maximum hydrogen storage amount determined according to the capacity of the hydrogen storage apparatus and a real-time hydrogen storage amount, and the surplus power of the power system is discharged (used) while a controllable voltage regulation amount (ΔVg) is fed back on the basis of the calculated power amount. Preferably, the eco-friendly energy storage system according to another embodiment of the present invention includes a water electrolysis apparatus and a hydrogen storage apparatus for performing discharge of surplus power for the power system; a fuel cell power generation apparatus for performing charge of deficiency power; and a control device for controlling charge and discharge by detecting a system voltage for controlling charge and discharge of the system, comparing the system voltage with a voltage reference value, and reflecting the system voltage regulation amount calculated on the basis of the hydrogen storage amount of the system.

Although the configuration of the present invention has been described in detail with reference to the preferred embodiments and accompanying drawings, this is only an example, and various modifications are possible without departing from the spirit of the present invention. Therefore, the scope of the present invention should not be limited to the described embodiments and should be defined by the claims described below and equivalents thereof.

### INDUSTRIAL APPLICABILITY

An energy storage system including a battery, such as a lead-acid battery, a lithium-ion battery (LIB), a sodium-sulfur (NaS) battery or a redox flow battery (RFB), has a disadvantage of maintaining ambient temperature to be constant and requires high maintenance cost, including the cost for periodic replacement of the battery as the performance of the battery is degraded according to the number of times of charge and discharge, the cost for disposal of harmful substances of disposed batteries, and the like, however, when energy is stored and produced, environmental-friendliness and durability of the eco-friendly energy storage system of the present invention, which uses clean pure hydrogen as a medium, are much superior to those of conventional energy storage systems. In addition, there is provided a method which can eco-friendly overcome output irregularity of a new renewable energy generator, in addition to instability of power caused by demands on the power of an independent power source that is not connected to the system.

1. An eco-friendly energy storage system for frequency regulation, the system comprising:
a water electrolysis apparatus and a hydrogen storage apparatus for performing discharge of surplus power for a power system;
a fuel cell power generation apparatus for performing charge of deficiency power; and
a control device for controlling charge and discharge by detecting a system frequency for controlling charge and discharge of the system, comparing the system frequency with a frequency reference value, and reflecting a frequency regulation amount calculated on the basis of a hydrogen storage amount of the system.

2. The system according to claim 1, including a method of actively controlling, when surplus power of the eco-friendly energy storage system is discharged, direct current voltage (V) of the water electrolysis apparatus to effectively convert the surplus power into hydrogen fuel through decrease and increase of an amount of DC current flowing through the water electrolysis apparatus and store the hydrogen fuel therein, and controlling, when deficiency power of the eco-friendly energy storage system is charged, an amount of current flowing through a fuel cell stack to control output in real time.

3. The system according to claim 1, wherein the water electrolysis apparatus of the system is any one among alkaline water electrolysis, polymer electrolyte membrane (PEM) water electrolysis, and anion electrolyte membrane (AEM) water electrolysis.

4. The system according to claim 1, wherein the fuel cell power generation apparatus of the system includes a hydrogen pressure controller and is any one among a polymer electrolyte membrane fuel cell (PEMFC), a phosphoric acid fuel cell (PAFC), and a solid oxide fuel cell (SOFC), which can use pure hydrogen as a fuel.

5. An eco-friendly energy storage system comprising:
a water electrolysis apparatus and a hydrogen storage apparatus for performing discharge of surplus power for a power system using a new renewable energy generator;
a fuel cell power generation apparatus for performing charge of deficiency power; and
a control device for controlling charge and discharge by detecting a system frequency for controlling charge and discharge of the system, comparing the system frequency with a frequency reference value, and reflecting a frequency regulation amount calculated on the basis of a hydrogen storage amount of the system.

6. The system according to claim 5, further comprising a compressor between the water electrolysis apparatus and the hydrogen storage apparatus of the system.

7. An eco-friendly energy storage system comprising:
a water electrolysis apparatus and a hydrogen storage apparatus for performing discharge of surplus power for a power system;
a fuel cell power generation apparatus for performing charge of deficiency power; and
a control device for controlling charge and discharge by detecting a system voltage for controlling charge and discharge of the system, comparing the system voltage with a voltage reference value, and reflecting a system voltage regulation amount calculated on the basis of a hydrogen storage amount of the system.
